(19) United States
(12) Patent Application Publication
(10) Pub. No.: US 2018/0262551 A1
(43) Pub. Date: Sep. 13, 2018

(54) EFFICIENT DELIVERY OF CUSTOMIZED CONTENT OVER INTELLIGENT NETWORK

(71) Applicant: Dolby Laboratories Licensing Corporation, San Francisco, CA (US)

(72) Inventors: Michael F. DEMEYER, Dublin, CA (US); Timothy E. ONDERS, Kirkland, WA (US)

(73) Assignee: Dolby Laboratories Licensing Corporation, San Francisco, CA (US)

(21) Appl. No.: 15/762,069

(22) PCT Filed: Sep. 21, 2016
(86) PCT No.: PCT/US2016/052941

§ 371 Date: Mar. 21, 2018

Related U.S. Application Data
(60) Provisional application No. 62/221,280, filed on Sep. 21, 2015.
(60) Provisional application No. 62/240,107, filed on Oct. 12, 2015.

(30) Foreign Application Priority Data
Nov. 5, 2015 (EP) 15193229.0

(51) Int. Cl. H04L 29/06; H04N 21/2343; H04N 21/258; H04N 21/2662

(52) U.S. Cl. CPC H04L 65/80; H04L 65/4092; H04N 21/2662; H04N 21/23439; H04N 21/25808; H04L 65/60

(57) ABSTRACT

In one embodiment, a method for optimizing delivery of a digital program having a plurality of selectable program components includes delivering to a first node a composite set of program components, assembling from the composite set first and second subsets of program components, the first and second subsets differing by at least one program component, delivering the first subset of program components to a first user, and delivering the second subset of program components to a second user. The program components relate to multiple program categories and each of the multiple program categories is associated with a program presentation aspect and comprises a plurality of selections.

### TECHNICAL FIELD

The present disclosure relates generally to delivery of customized digital content over a network.

### BACKGROUND

The delivery of digital content, such as audio/video programming, music, and the like, from content providers to end users can suffer from inefficiencies if it fails to take into account user preferences, network capabilities and conditions, among many other factors. Content providers who serve multiple clients often deliver the same complete set of content to each client. Depending on the preferences of the client and/or the agreement between the client and the provider, the client may then extract only the content to which it is entitled or desires. Such a method of delivery is wasteful of delivery resources since many clients only need a subset of the content that has been provided to present the desired experience. An example might be delivering multiple audio languages for a movie, when the viewer only desires to hear one language. While commonly-deployed systems today attempt to solve this by allowing the client to request only selected components from the service, which does reduce the transmission of unneeded program components, this approach suffers from performance limitations including latency when the component selection is changed. As interactivity of content experiences increases, these latencies become unacceptable to the user experience.

### OVERVIEW

Described herein is a method for optimizing delivery of a digital program having a plurality of program components that are selectable by a client. The program components may relate to multiple program categories and each of the multiple program categories may be associated with a program presentation aspect and may comprise a plurality of selections. For example, the program components may be selected from one or more of the multiple program categories comprising audio, video, camera or film feeds that include differences in commentator language, commentator tone, stadium ambience, alternate language commentators, ambient sound from a camera, team radio, in-car audio, viewer expertise, music and effect, or metadata related to the audio/video elements or the program as a whole. In other words, the plurality of program components may comprise components of different program categories. Each category may have a plurality of selectable components.

The method includes delivering to a first node a composite set of program components, assembling from the composite set first and second subsets of program components, the first and second subsets differing by at least one program component, delivering the first subset of program components to a first user, and delivering the second subset of program components to a second user. The method further includes delivering to the first node repackaging data associated with the composite set of program components. The repackaging data may provide data for presentations of the program components at destination devices. The subsets of program components may be selected based on the repackaging data, for example based on a selected presentation at a destination device, which then determines the repackaging of program components, e.g. which components associated with the selected presentation are selected for a subset. In addition, the repackaging data may comprise precomputed data that is included in a stream comprising a subset. Moreover, the first and/or second subsets of program components may be delivered to a second node from the first node on the network. By doing this, the repackaged content for delivery to other users or for different purposes can be efficiently generated, thereby improving content delivery efficiency and reducing cost for delivery of customized streams comprising program components that relate to multiple program categories. In other words, optimized delivery of customized streams can be achieved by applying the disclosed method.

Also described herein is a method for optimizing delivery of a digital program having a plurality of selectable program components. As mentioned above, the program components may relate to multiple program categories and each of the multiple program categories may be associated with a program presentation aspect and may comprise a plurality of selections. The program components may be selected from one or more of the multiple program categories. The method includes receiving at a first node a composite set of program components, assembling from the composite set first and second subsets of program components, the first and second subsets differing by at least one program component, delivering the first subset of program components to a first user, and delivering the second subset of program components to a second user. The method further includes delivering to the first node repackaging data associated with the composite set of program components. The repackaging data may provide data for presentations of the program components at destination devices. A subset of program components may be selected based on the repackaging data, for example based on a selected presentation at a destination device. The selected presentation then determines the selection of program components for repackaging, e.g. which components associated with the selected presentation are selected for a subset. In addition, the repackaging data may comprise precomputed data that is included in a stream comprising a subset. Moreover, the first and/or second subsets of program components may be delivered to a second node from the first node on the network. As mentioned above, optimized delivery of customized streams comprising program components that relate to multiple program categories can be achieved by applying the disclosed method.

Also described herein is a non-transitory program storage device readable by a machine, embodying a program of instructions executable by the machine to perform the aforementioned method for optimizing delivery of a digital program having a plurality of selectable program components.

Also described herein is a system for custom delivery of a digital program having a plurality of selectable program components. The program components may relate to multiple program categories and each of the multiple program categories may be associated with a program presentation aspect and may comprise a plurality of selections. For example, the program components may be selected from one or more of the multiple program categories comprising audio, video, camera or film feeds that include differences in commentator language, commentator tone, stadium ambience, alternate language commentators, ambient sound from a camera, team radio, in-car audio, viewer expertise, music and effect, or metadata related to the audio/video elements or the program as a whole. The system includes a source processor having a multiplexer for multiplexing two or more of the program components into a composite data stream, and an appender for appending assembly data to the data stream. It should be noted that the assembly data may provide data structures for presentations of the program components. The system also includes a destination processor having an extractor for receiving the composite data stream and selectively extracting program components therefrom, and a repackager for packaging the selectively extracted program components into a custom stream.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a block diagram of a system for efficient delivery of customized content from content providers to end users in accordance with certain embodiments;

FIG. 2 is a block diagram of packaging platform in accordance with certain embodiments; and

FIG. 3 is a block diagram of repackaging platform accordance with certain embodiments.

### DESCRIPTION OF EXAMPLE EMBODIMENTS

Example embodiments are described herein in the context of a system of computers, servers, and network and storage devices. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

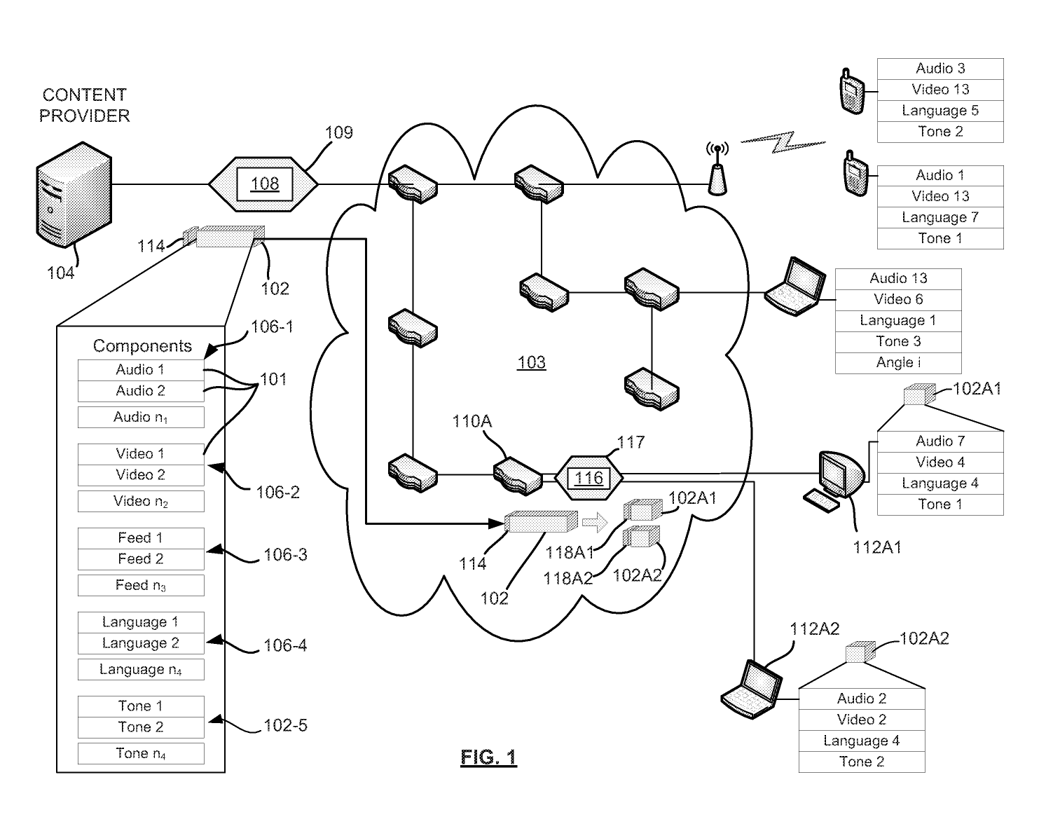

FIG. 1 is a block diagram of a system for efficient delivery of customized content from content providers to end users in accordance with certain embodiments. The delivered content is experienced by end users in the form of media presentations whose delivery to the user is optimized based on such factors as the user's personal preferences, service agreement, and the capabilities and prevailing conditions of the user's playback device and of the network and infrastructure through which the delivery is effected. In certain embodiments, a media presentation can for example be a video or audio program, or the like, and can relate to a sports event, movie, television program, song or music, televised political speech, a virtual reality presentation, and descriptive non-media information (metadata) that is carried with and related to the presentation of the media and so on.

Considering the example of a sports event, it can be characterized by several audio and/or video and/or other components. Examples of such program components include, but are not limited to, a particular audio or a particular video associated with the event, the camera or film feed (for example from a live camera mounted in one particular race car or from a fixed location above the racetrack, etc.), commentator language, commentator tone (favorable to one team or another, or neutral), audio elements such as stadium or crowd sounds that provide a more realistic and immersive experience, metadata related to the media elements and/or the overall program, and so on. In other words, media presentations and/or presentations of program content may relate to a variety of aspects comprising program components such as audio, video, the camera or film feed, commentator language, commentator tone, audio elements, metadata and other possible program components. If one considers the aspect of content delivery from the top-down, a set of presentations is the highest level element. Each presentation is comprised of one or more program components, which might be from the same or different categories.

In the case of a Virtual Reality (VR) experience, these might be different audio or video components corresponding to the orientation of the user's head. The most appropriate set of these components (audio, video, feed, language, tone, metadata, etc.) can be selected, and a package assembled based on the aforementioned conditions, such as user preference, delivery network and infrastructure conditions, end-user device capabilities and specifications, in order to optimize delivery efficiency and cost, and improve user experience. Table 1 provides a non-exhaustive list of audio program components that can be selected from for a team sports event example, an auto racing example, and an episodic television example.

TABLE 1

Team sports example:
Stadium ambience
Commentators (team-biased, neutral, etc.)
Alternate language commentators
Auto racing example:
Ambient sound from current camera
Team radios (one or more of many)
In-car audio (one of many, with matching video)
Commentator for expert viewers
Commentator for novice viewers
Alternate language commentator
Episodic television example:
Music and effects track (M&E)
Primary language
Alternate language(s)
Descriptive audio (for visually impaired)

Turning again to FIG. 1, the program components 101 are part of a program component set 102 that is disposed at a first portion of a network 103 that can include sub-networks and the Internet. A server 104, labeled “content provider” for convenience, is shown associated with the program component set 102, but it is to be understood that multiple servers or processing devices and data stores can be used to generate, aggregate and store the presentation components from a single or disparate sources. As mentioned above, presentations of program content relate to a variety of aspects comprising program components such as audio, video, the camera or film feed, commentator language, commentator tone, audio elements, metadata and other possible program components. Thus, the program components of set 102 relate to multiple program categories which are associated with different program presentation aspects/characteristics. In other words, a program component set 102 may comprise program components of different categories. Each category may comprise a plurality of selectable program components. Five program categories, 106-1 through 106-5 (collectively 106) are depictedaudio, video, feed, language, and tonebut this list is not exhaustive. Each program category 106 consists of different selections. For example, in the audio category 106-1, 1 through n₁ different audio selections are present. Examples of audio are MP3 and AAC. In the language category, 1 through n₄ language selections are present. Examples of languages are English, Spanish, French, Arabic, Mandarin Chinese, and so on. Other program categories which are not mentioned herein can also be used for indicating other possible presentation aspects. Moreover, a different event than the above mentioned sport event may be characterized by other program components/categories different than the program components/categories as illustrated in FIG. 1.

In certain embodiments, a packaging platform 108 at a source node 109 is used to package the program components, in their entirety, for delivery to a location in the network that is more accessible to an end user. In certain embodiments, the components are prepackaged, and the packaging platform is not required. The source node 109 can be any one or more processing devices, such as a server, switch, router, or other computing device. Accessibility can be defined in economic terms, for instance a less costly data rate, or more generally in computational terms, or in terms of time and speed, or power consumption, or in terms of integrity, with less loss of data, with lower delivery latency, or in any other terms or combinations of terms by which network delivery efficiency, speed, performance and costs are measured.

In certain embodiments, a more accessible location is an intermediate device that is “closer” in the network than the content provider 104 to one or more end users. A computing device such as router 110A is schematically illustrated as closer, with fewer hops or nodes between it and end users 112A1 and 112A2 for instance than between server 104 and the end users. Accordingly, in certain embodiments, the program components of set 102 are therefore sent to router 110A in anticipation of further transmission to the end user.

Because each end-user is only interested in receiving a subset of the program component set 102, router 110A is operative to unpack program component set 102, and repackage subsets of the program components for delivery to the end-users. For end-user 112A1, a first subset 102A1 is assembled and repackaged by router 110A for delivery to end-user 112A1; for end-user 112A2, a second subset 102A2, which may be different from the first subset, is assembled and repackaged by router 110A for delivery to end-user 112A1.

In order to effect proper assembly and repackaging of the presentation components, for example by router 110A, original program component set 102 is augmented with other data 114 pertaining to the assembly of the program components into individual end-user presentations. The other data 114 (“repackaging data” or “assembly data”) in certain embodiments provides pre-computed data (e.g. data structures) for anticipated presentations that will be repackaged and optimizes the repackaging function. In other words, the repackaging/assembly data 114 can indicate to a node (e.g. the router 110A) the way how to repackage or assemble the program components for a particular presentation to provide a customized stream of the program components to a corresponding end user. For example, the repackaging/assembly data 114 may indicate the node 110A to repackage the program components comprising “stadium ambience”, “commentators” and “alternate language commentators” into a customized stream presentation to be sent to an end user who intends to watch the team-sport program. The use of repackaging data 114 can thus improve the efficiency of the assembly process. In certain embodiments, without repackaging data 114, the process of extracting and repackaging the content into a valid stream would be more computationally complex, making it more difficult to perform economically on the nodes at the network edge, as described below. In some cases, without this repackaging data, the process could not be performed economically.

Thus, the disclosed method delivers, to the intermediate device, a composite set of program components together with other repackaging/assembly data 114 which provide information such as data structures for anticipated presentations of the program components at a destination node. The augmentation with other data 114 is conducted by platform 108 at source node 109. The repackaging data 114 is used by an assembling and repackaging platform 116 in properly formulating the subsets 102A1 and 102A2. Platform 116 is disposed at a first destination node 117 on or in the vicinity of router 110A, which serves customized subset 102A1 to end-user 112A1, and a potentially different, customized subset 102A2 to end-user 112A2. Since one goal of the repackaging data 114 is to improve the efficiency of the assembly process, platform 116 may therefore be a “thin” device with minimal computational requirements.

An aspect of this disclosure is to allow the extraction of program elements that make up one or more presentation(s) and efficiently repack those elements and presentation(s) into a new stream to send only that subset further in the network. The repackaging data could be associated with presentations (as defined above) of the program components. In other words, the repackaging data may comprise data structures associated with presentations at destination devices. The repackaging data corresponding to a selected presentation may determine subsets of program components that are selected for repackaging and inclusion in the new stream. In other words, the repackaging data determines the repackaging of program components, e.g. which components associated with a selected presentation are selected for a subset. In addition, the repackaging data may comprise precomputed data for a subset or a presentation that is included in the stream. Thus, by the inclusion of repackaging data it is possible to improve the efficiency of creating a new stream containing a subset of the components to service the needs of a particular user or users.

The suggested repacking will be further explained by the following example. Assume that the original composite set of program components includes a 5.1-channel music and sound effects (M&E) component and two mono narration components, one in English and one in Spanish. It also contains data to define two presentations, one that combines the M&E with English narration and one that combines the M&E with Spanish narration. The first user requests to receive the program in the Spanish language. At the first node, the 5.1-channel M&E component and the Spanish language narration component are extracted from the original composite set and a new subset is formed that contains only those two components and the data to define a single presentation. Since the English narration component has been omitted, the resulting package is smaller and requires less network bandwidth to deliver.

However, creating this new composite set (i.e. subset) requires computational work, for example, it might be necessary to re-compute a hash value used to verify the integrity of the new subset when it is received by the user. Computing this hash value can be computationally expensive, so it is undesirable to perform on a ‘computationally expensive’ network resource. In this example, the repackaging data in the original composite set could include a pre-computed hash value associated with each of the presentations calculated only once when the original composite set is created at the source that can be inserted into the new subset that is being sent from first node to the first user. This eliminates the need to do this potentially complex (and, therefore, expensive) computation each time a ‘Spanish language’ subset is created for delivery to a user who only wants Spanish.

In the above example, a specific kind of repackaging data, namely pre-computed security hash values associated with the repackaged stream, was provided. This is a very real example of a type of element (of the new stream) that can be computationally expensive to create and, yet, would be the same for any repackaged stream containing the same elements and presentations. Therefore, computing this one time during the creation of the source stream eliminates this computational activity on the network node. This is especially economical when the same sub-stream will be created many times for different users. Another type of pre-′computed′ (or pre-constructed) data might be table-of-contents structures for the new sub-stream. The best opportunities to optimize are elements that are ‘expensive’ to construct given the capabilities of the node that is doing the repackaging. Those could be elements that require computation on large data sets (the security hash for example, since it has to examine the entire audio/video stream) in a node with limited processing resources.

Referring again to FIG. 1, destination node 117 can include any one or more processing devices, such as a server, switch, router (such as router 110A), or other computing device equipped to run platform 116, and may be provided with caching capabilities, enabling the reuse of the repackaged content for delivery to other users or for different purposes, in order to improve efficiency and reduce cost. In certain embodiments, platform 116 is also operative to augment the subsets 102A1 and 102A2 with additional, unpacking data 118A1, 118A2, that enables the particular destination device (for example end users 112A1, 112A2) to properly unpack them for playback, storage, or other uses. Similar to the repackaging/assembly data 114, unpacking data 118A1, 118A2 also relate to the assembly of the program components into individual end-user presentations. In certain embodiments, unpacking data 118A1, 118A2 can be delivered to end users 112A1, 112A2 for a subsequent assembly of the program components of the customized subsets 102A1, 102A2 according to a presentation that is associated with the unpacking data. Thus, by providing unpacking data for anticipated presentations to destination devices, the presentation of the program content based on such anticipated presentation schema at destination devices is facilitated.

In certain embodiments, a cascaded system is envisioned, in which a subset that still contains multiple presentations is sent to another node on the network for subsequent unpacking/repacking, for delivery to still further nodes, that in turn further repackage and deliver the content to end users, and so on. In other words, the stream might contain additional pre-computed repackaging data to aid with subsequent packaging of smaller subsets. In general, the repacking data 114 may provide pre-computed data for anticipated presentations to be repackaged to optimize the repackaging function. The repackaging/assembly data 114 may be associated with a subset of program components for subsequent unpacking/repacking at a further node to enable the reuse of the repackaged content for delivery to other users or nodes. An example of this is the sending of multiple presentations in a particular language (for example Spanish) to a network node in Spain, since there are many end-users there who want Spanish language presentations in various forms. This cascaded delivery could be very economically beneficial. Another example may be the sending of multiple presentations with a certain bit rate to a network node where different languages and/or tones are requested. Thus, the use of the repackaging data 114 can enable optimized delivery of customized streams comprising program components that relate to multiple program categories.

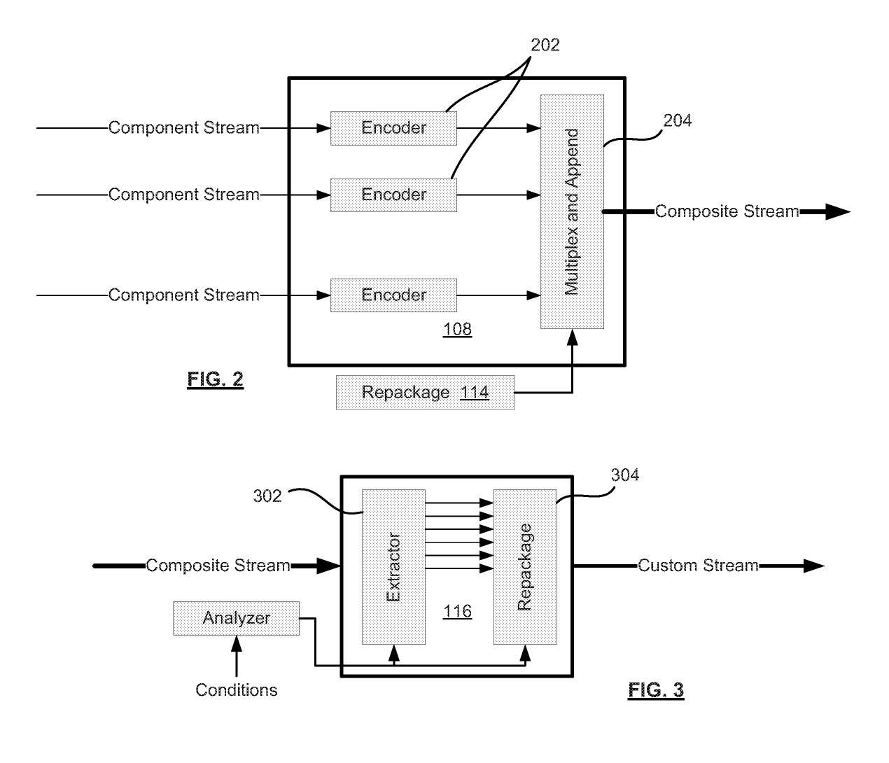

FIG. 2 is a block diagram of packaging platform 108, which may be one or more modules executing on a processor or similar computing device, which may be referred to herein as a source processor. Program components, in the form of data streams in certain embodiments, are encoded by corresponding encoders 202, and then multiplexed together into a composite stream by multiplex and append module 204, which also appends the repackaging data 114. A composite data stream is then output for delivery to other network destinations, such as router 110A. In some embodiments, the composite stream can reach the end user directly and be suitable for playback by the end user, without resort to intermediaries such as node 117 and platform 116.

FIG. 3 is a block diagram of repackaging platform 116, which includes an extractor 302 which extracts suitable program components from the composite stream, based on customization information generated by an analyzer 306 as a function of the aforementioned conditions, such as the desired user experience or preferences, network storage or computation costs, network bandwidth costs or real-time performance conditions, end user device capabilities and specifications, and so on, in order to optimize delivery efficiency and cost and improve user experience. Repackaging platform 116 may be a module executing on a processor or similar computing device. Said processor or similar computing device may be referred to herein as a destination processor. The extraction is optimized by taking advantage of the repackaging data 114 that directs proper extraction and/or optimizes repackaging. Repackage module 304 then combines the selected program components, again in accordance with repackaging data 114 and the input delivery and use information, for forwarding to the end-user or another downstream destination processor in customized form.

In certain embodiments, the destination processor (i.e. repackaging platform 116) may be configured to augment a customized stream of program components with additional repackaging data 114 for a subsequent repackaging of the program components of the customized stream. For example, the destination processor 116 may further comprise another append module which is similar to the append module 204 of the source processor (i.e. packaging platform 108) to append the repackaging data 114. Subsequently, the customized stream of program components together with the packing data 114 are forwarded to the end-user or another downstream destination processor for subsequent unpacking/repacking. By doing this, the repackaged content for delivery to other users or for different purposes can be reused, thereby improving efficiency and reducing cost for delivery of customized streams comprising program components that relate to multiple program categories. In other words, optimized delivery of customized streams can be achieved by applying the disclosed method.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

Various aspects of the present invention may be appreciated from the following enumerated example embodiments (EEEs).

EEE 1. A method for optimizing delivery of a digital program having a plurality of selectable program components, the method comprising:

delivering to a first node a composite set of program components;

delivering to the first node repackaging data associated with the composite set of program components;

assembling from the composite set first and second subsets of program components, the first and second subsets differing by at least one program component, wherein said assembling is optimized using the repackaging data; and

delivering the first subset of program components to a user.

EEE 2. The method of EEE 1, wherein assembling is conducted in accordance with an analysis of conditions selected from one or more of network conditions, end user device capabilities and specifications, desired user experience, desired user preference, network storage or computation costs, bandwidth costs, and real-time performance
EEE 3. The method of EEE 1, wherein the digital program relates to a media presentation of a video or audio program, podcast, sports event, movie, television program, song, music, virtual reality presentation, or televised political speech.
EEE 4. The method of EEE 1, wherein the program components are selected from one or more of audio, video, camera or film feeds that include differences in commentator language, commentator tone, stadium ambience, alternate language commentators, ambient sound from a camera, team radio, in-car audio, viewer expertise, music and effect, or metadata related to the audio/video elements or the program as a whole.
EEE 5. The method of EEE 1, further comprising delivering the second subset of program components to a user.
EEE 6. A method for optimizing delivery of a digital program having a plurality of selectable program components, the method comprising:

receiving at a first node a composite set of program components;

receiving at the first node repackaging data associated with the composite set of program components;

assembling from the composite set first and second subsets of program components, the first and second subsets differing by at least one program component, wherein said assembling is optimized using the repackaging data; and

delivering the first subset of program components to a user.

EEE 7. The method of EEE 6, wherein assembling is conducted in accordance with an analysis of conditions selected from one or more of network conditions, end user device capabilities and specifications, desired user experience, desired user preference, network storage or computation costs, bandwidth costs, and real-time performance
EEE 8. The method of EEE 6, wherein the program components are selected from one or more of audio, video, camera or film feed, commentator language, and commentator tone, stadium ambience, alternate language commentators, ambient sound from a camera, team radio, in-car audio, viewer expertise, music and effect, or metadata related to the audio/video elements or the program as a whole.
EEE 9. The method of EEE 6, further comprising delivering the second subset of program components to a user.
EEE 10. A non-transitory program storage device readable by a machine, embodying a program of instructions executable by the machine to perform a method for optimizing delivery of a digital program having a plurality of selectable program components, the method comprising:

receiving at a first node a composite set of program components;

receiving at the first node repackaging data associated with the composite set of program components;

assembling from the composite set first and second subsets of program components, the first and second subsets differing by at least one program component, wherein said assembling is optimized using the repackaging data; and

delivering the first subset of program components to a user.

EEE 11. The device of EEE 10, wherein assembling is conducted in accordance with an analysis of conditions selected from one or more of network conditions, end user device capabilities and specifications, desired user experience, desired user preference, network storage or computation costs, bandwidth costs, and real-time performance.
EEE 12. The device of EEE 10, wherein the program components are selected from one or more of audio, video, camera or film feed, commentator language, and commentator tone, stadium ambience, alternate language commentators, ambient sound from a camera, team radio, in-car audio, viewer expertise, music and effect, or metadata related to the audio/video elements or the program as a whole.
EEE 13. The device of EEE 10, wherein the method further comprises delivering the second subset of program components to a user.
EEE 14. A system for custom delivery of a digital program having a plurality of selectable program components, the system comprising:

a source processor including:
a multiplexer for multiplexing two or more of the program components into a composite data stream, and
an appender for appending assembly data to the data stream; and

a destination processor including:
an extractor for receiving the composite data stream and selectively extracting program components therefrom, and
a repackager for packaging the selectively extracted program components into a custom stream.
   EEE 15. The system of EEE 14, further including an analyzer for directing the operation of at least one of the extractor or repackager as a function of condition information received by the analyzer.
   EEE 16. The system of EEE 14, wherein the analyzer receives as input information relating to conditions selected from one or more of network conditions, end user device capabilities and specifications, desired user experience, desired user preference, network storage or computation costs, bandwidth costs, and real-time performance.
   EEE 17. The system of EEE 14, wherein the program components are selected from one or more of audio, video, camera or film feed, commentator language, and commentator tone, stadium ambience, alternate language commentators, ambient sound from a camera, team radio, in-car audio, viewer expertise, music and effect, or metadata related to the audio/video elements or the program as a whole.

What is claimed is:

1-16. (canceled)

17. A method for optimizing delivery of a digital program having a plurality of selectable program components, the method comprising:
delivering to a first node a composite set of program components;
delivering to the first node repackaging data associated with the composite set of program components;
assembling from the composite set first and second subsets of program components, the first and second subsets differing by at least one program component, wherein said assembling is optimized using the repackaging data; and
delivering the first subset of program components to a user.

18. The method of claim 17, wherein assembling is conducted in accordance with an analysis of conditions selected from one or more of network conditions, end user device capabilities and specifications, desired user experience, desired user preference, network storage or computation costs, bandwidth costs, and real-time performance

19. The method of claim 17, wherein the digital program relates to a media presentation of a video or audio program, podcast, sports event, movie, television program, song, music, virtual reality presentation, or televised political speech.

20. The method of claim 17, wherein the program components are selected from one or more of audio, video, camera or film feeds that include differences in commentator language, commentator tone, stadium ambience, alternate language commentators, ambient sound from a camera, team radio, in-car audio, viewer expertise, music and effect, or metadata related to the audio/video elements or the program as a whole.

21. The method of claim 17, further comprising delivering the second subset of program components to a user.

22. A method for optimizing delivery of a digital program having a plurality of selectable program components, the method comprising:
receiving at a first node a composite set of program components;
receiving at the first node repackaging data associated with the composite set of program components;
assembling from the composite set first and second subsets of program components, the first and second subsets differing by at least one program component, wherein said assembling is optimized using the repackaging data; and
delivering the first subset of program components to a user.

23. The method of claim 22, wherein assembling is conducted in accordance with an analysis of conditions selected from one or more of network conditions, end user device capabilities and specifications, desired user experience, desired user preference, network storage or computation costs, bandwidth costs, and real-time performance

24. The method of claim 22, wherein the program components are selected from one or more of audio, video, camera or film feed, commentator language, and commentator tone, stadium ambience, alternate language commentators, ambient sound from a camera, team radio, in-car audio, viewer expertise, music and effect, or metadata related to the audio/video elements or the program as a whole.

25. The method of claim 22, further comprising delivering the second subset of program components to a user.

26. A non-transitory program storage device readable by a machine, embodying a program of instructions executable by the machine to perform a method for optimizing delivery of a digital program having a plurality of selectable program components, the method comprising:
receiving at a first node a composite set of program components;
receiving at the first node repackaging data associated with the composite set of program components;
assembling from the composite set first and second subsets of program components, the first and second subsets differing by at least one program component, wherein said assembling is optimized using the repackaging data; and
delivering the first subset of program components to a user.

27. The device of claim 26, wherein assembling is conducted in accordance with an analysis of conditions selected from one or more of network conditions, end user device capabilities and specifications, desired user experience, desired user preference, network storage or computation costs, bandwidth costs, and real-time performance.

28. The device of claim 26, wherein the program components are selected from one or more of audio, video, camera or film feed, commentator language, and commentator tone, stadium ambience, alternate language commentators, ambient sound from a camera, team radio, in-car audio, viewer expertise, music and effect, or metadata related to the audio/video elements or the program as a whole.

29. The device of claim 26, wherein the method further comprises delivering the second subset of program components to a user.

30. A system for custom delivery of a digital program having a plurality of selectable program components, the system comprising:
a source processor including:
a multiplexer for multiplexing two or more of the program components into a composite data stream, and
an appender for appending assembly data to the data stream; and
a destination processor including:
an extractor for receiving the composite data stream and selectively extracting program components therefrom, and
a repackager for packaging the selectively extracted program components into a custom stream.

31. The system of claim 30, further including an analyzer for directing the operation of at least one of the extractor or repackager as a function of condition information received by the analyzer.

32. The system of claim 30, wherein the analyzer receives as input information relating to conditions selected from one or more of network conditions, end user device capabilities and specifications, desired user experience, desired user preference, network storage or computation costs, bandwidth costs, and real-time performance.

33. The system of claim 30, wherein the program components are selected from one or more of audio, video, camera or film feed, commentator language, and commentator tone, stadium ambience, alternate language commentators, ambient sound from a camera, team radio, in-car audio, viewer expertise, music and effect, or metadata related to the audio/video elements or the program as a whole.
